(19) United States
(12) Patent Application Publication
(10) Pub. No.: US 2025/0307143 A1
(43) Pub. Date: Oct. 2, 2025

(54) Stacked Die Extension Over Processor Core

(71) Applicant: Advanced Micro Devices, Inc., Santa Clara, CA (US)

(72) Inventors: Paul James Moyer, Fort Collins, CO (US); Christopher Spence Oliver, Austin, TX (US); John Kalamatianos, Arlington, MA (US)

(73) Assignee: Advanced Micro Devices, Inc., Santa Clara, CA (US)

(21) Appl. No.: 18/622,376

(22) Filed: Mar. 29, 2024

(51) Int. Cl. G06F 12/0802

(52) U.S. Cl. CPC G06F 12/0802; G06F 2212/60

(57) ABSTRACT

A stacked die extension over a processor core to improve thermal management, communication latency, and routing complexity of semiconductor devices is described. In one or more implementations, a stacked-die semiconductor device includes a first die having a processor core, and at least one second die including a processor-core extension positioned either above or below a portion of the processor core. In one or more implementations a system includes a stacked-die semiconductor device and a memory device. The stacked-die semiconductor device has a first die that includes a processor core and at least one second die that includes a processor-core extension positioned either above or below a portion of the processor core. The memory device is operatively coupled to the processor-core extension to exchange data with the processor core.

### BACKGROUND

A processing device is often implemented on a semiconductor die that includes a processor core integrated with a hardware block including various other elements that support functionality of the core. Among these other elements is a cache extension or floating-point unit arranged outside the core. A long separation distance between the core and these outside elements causes communication latency to be high and increases complexity of power and signal routing between them. Overall thermal management of the processing device is more difficult when the core and the hardware block (e.g., the cache extension, the floating-point unit) are far apart. The core runs much hotter than the outside elements and complicated heatsink designs are used to cool various regions of the die differently.

### BRIEF DESCRIPTION OF THE DRAWINGS

FIG. 1 is a block diagram of a non-limiting example system that uses a stacked die extension over a processor core.

FIG. 2 depicts a non-limiting example top-view and side-view of a system with a stacked die extension over a processor core.

FIG. 3 depicts a non-limiting example of a stacked die extension over a processor core being cooled by a heatsink.

FIG. 4 depicts a non-limiting example of a stacked die extension over a processor core including one or more die-to-die interconnects.

FIG. 5 depicts a procedure performed in an example implementation of a stacked die extension over a processor core.

FIG. 6 depicts a procedure for forming an example implementation of a stacked die extension over a processor core.

### DETAILED DESCRIPTION

Processing devices, such as a central processing unit (CPU), a graphics processing unit (GPU), an accelerator unit, a system on chip (SoC), and the like, are often implemented on semiconductor dies. In conventional processing devices, a semiconductor die typically includes a processor core. The processor core includes various elements, such as components for a level one cache (e.g., a data cache, an instruction cache, a cache controller, a load store unit). Partially surrounding the processor core are various supporting elements of the core. Typical supporting elements include a cache extension (e.g., a level two cache, a level three cache) and a floating-point unit.

Performance in conventional systems suffers when the supporting elements are arranged on the same die as, but external to, a processor core. A long separation distance between the processor core and the supporting elements causes high communication latency and increases complexity of power and signal routing between them. Overall thermal management of the processing device is more difficult because the core runs much hotter than the outside elements, which causes an inconsistent thermal footprint across the die. With distal regions on the die producing less heat than at the core, complicated heatsink designs are used to cool various die regions differently.

In contrast to conventional systems, a stacked die extension over a processor core is described. By way of example, a system includes a processor core arranged within a first die (e.g., a main die) of a stacked-die semiconductor device. In one or more implementations, the first die is supported by a planar substrate defined by two orthogonal axes (e.g., x-axis and y-axis), which extend in different lateral directions (e.g., x-direction and y-direction) on a common plane (e.g., x-y plane). Unlike conventional systems, at least one supporting element for the core, referred to herein as a processor-core extension, is stacked vertically (e.g., in a z-direction to the x-y plane) on at least one second die (e.g., a vertical die) that is above or below the first die. In one or more implementations, the processor-core extension is positioned within this second die. For example, the processor-core extension includes a cache extension (e.g., a level two cache, a level three cache), a floating-point unit, a programmable accelerator extension, a matrix extension for matrix math, a branch prediction unit, an artificial intelligence accelerator, an audio accelerator, a video accelerator, and/or a cryptography extension for encryption or decryption of data exchanged with the processor core. In one or more implementations, using the stacked die extension that is stacked relative the processor core in accordance with the techniques described herein, improves thermal management, communication latency, and routing complexity of semiconductor devices.

Stacking the processor-core extension containing one or more supporting elements of the core overcomes communication and routing challenges of conventional systems. While the stacked elements are on a vertically separate die from the core, they are closer to the core than other elements arranged outside the core on the main die. This vertical arrangement reduces communication latency and complexity of power and signal routing between the stacked elements and the core. In one or more implementations, a die-to-die interconnect is arranged between the first die and the second die to quickly transfer power and signals between the processor core and the supporting elements of the processor-core extension that are stacked above or below the first die.

Integrating the processor-core extension to be over or under part of the core reduces complexity of thermal management for the stacked-die semiconductor device. In at least one aspect, a heatsink, which has an approximately uniform thickness across the stacked-die semiconductor device, is added to the system to dissipate thermal energy. Even though one or more elements of the processor-core extension within the second die tend to operate cooler than elements of the core on the first die, this simpler heatsink design is sufficient to cool the various regions of the stacked-die semiconductor device because the overall heat signature caused by the stacking is consistent across the stacked-die semiconductor device.

In some aspects, the techniques described herein relate to a stacked-die semiconductor device including a first die having a processor core, and at least one second die including a processor-core extension positioned either above or below a portion of the processor core.

In some aspects, the techniques described herein relate to a stacked-die semiconductor device, wherein the processor-core extension includes a cache extension operatively coupled to the processor core.

In some aspects, the techniques described herein relate to a stacked-die semiconductor device, wherein the first die further includes a cache operatively coupled to the cache extension.

In some aspects, the techniques described herein relate to a stacked-die semiconductor device, wherein the cache extension is a higher order cache than the cache within the first die.

In some aspects, the techniques described herein relate to a stacked-die semiconductor device, wherein the portion of the processor core includes at least part of the cache within the first die.

In some aspects, the techniques described herein relate to a stacked-die semiconductor device, wherein the portion of the processor core includes at least one of a data cache of the cache within the first die, a load store unit of the cache within the first die, or a load store unit of the cache extension.

In some aspects, the techniques described herein relate to a stacked-die semiconductor device, wherein the cache within the first die includes a first order cache operatively coupled to the processor core, the cache extension includes a second order cache operatively coupled to the processor core, and the stacked-die semiconductor device further includes at least one third die with a third order cache operatively coupled to the processor core.

In some aspects, the techniques described herein relate to a stacked-die semiconductor device, further including a die-to-die interconnect arranged between the first die and the at least one second die to transfer power and signals between the processor core and the processor-core extension.

In some aspects, the techniques described herein relate to a stacked-die semiconductor device, wherein the die-to-die interconnect includes at least one of micro bumps, hybrid bonds, or through-silicon vias.

In some aspects, the techniques described herein relate to a stacked-die semiconductor device, wherein the processor-core extension includes a floating-point unit operatively coupled to the processor core.

In some aspects, the techniques described herein relate to a system including a stacked-die semiconductor device that includes a first die that includes a processor core and at least one second die that includes a processor-core extension positioned either above or below a portion of the processor core, and a memory device operatively coupled to the processor-core extension to exchange data with the processor core.

In some aspects, the techniques described herein relate to a system, further including a heatsink configured to dissipate thermal energy from the stacked-die semiconductor device.

In some aspects, the techniques described herein relate to a system, wherein the at least one second die is positioned between the first die and the heatsink.

In some aspects, the techniques described herein relate to a system, wherein the heatsink includes an approximately uniform thickness relative the processor-core extension and the processor core.

In some aspects, the techniques described herein relate to a system, wherein the processor-core extension includes a floating point unit operatively coupled to the processor core.

In some aspects, the techniques described herein relate to a system, wherein the processor-core extension includes a cache extension operatively coupled to the processor core.

In some aspects, the techniques described herein relate to a system, wherein the processor-core extension includes at least one of a programmable accelerator extension, a matrix extension for matrix math, a branch prediction unit, an artificial intelligence accelerator, an audio accelerator, a video accelerator, or a cryptography extension for encryption or decryption of the data exchanged with the processor core.

In some aspects, the techniques described herein relate to a method of forming a stacked-die semiconductor device, the method including integrating a processor core within a first die of the stacked-die semiconductor device, arranging at least one second die of the stacked-die semiconductor device either above or below the first die, and integrating a processor-core extension within the at least one second die either above or below a portion the processor core.

In some aspects, the techniques described herein relate to a method, wherein the portion of the processor core includes a level one cache and a level one load store unit, and integrating the processor-core extension includes integrating a level two cache or a level three cache within the at least one second die either above or below the level one load store unit of the processor core.

In some aspects, the techniques described herein relate to a method, further including arranging a heatsink having an approximately uniform thickness adjacent to the at least one second die such that the processor-core extension is between the heatsink and the processor core.

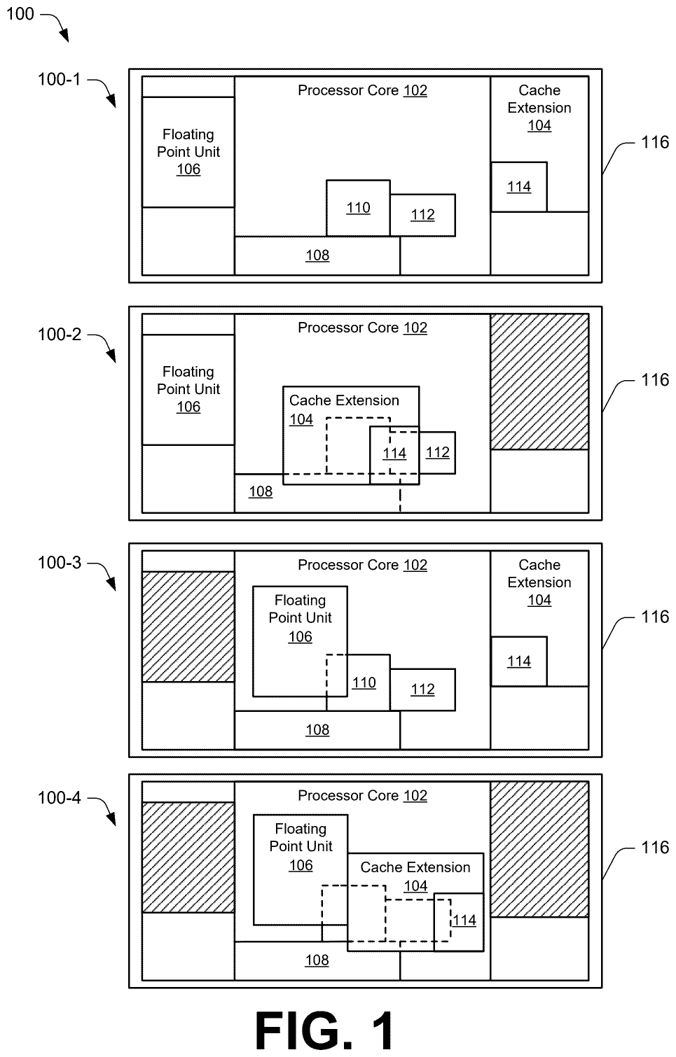

FIG. 1 is a block diagram of non-limiting examples of systems 100 that uses a stacked die extension over a processor core. The systems 100 are individually labeled in FIG. 1 as a system 100-1, a system 100-2, a system 100-3, and a system 100-4. Each of the systems 100 represents an example of a processing device implemented on a stacked-die semiconductor device referred to as a semiconductor device 116. The components of the systems 100 are functionally similar, however, each of the systems 100 provides a different layout to the components, depending on a quantity of stacked die extensions being used. The system 100-1 represents an implementation where no stacked die extensions are used, and the system 100-2, the system 100-3, and the system 100-4 are example implementations where at least one stacked die extension is implemented.

It is to be appreciated that in variations, the systems 100 and the individual components illustrated therein include more, fewer, and/or different hardware components without departing from the spirit or scope of the described techniques, e.g., further caches, semiconductor intellectual property (IP) cores, networking interfaces, other controllers, memory devices, accelerator cores, etc. In one example for instance, an interface to a memory device and/or an accelerator device is operable with an interface of the processor core 102.

Examples of devices or apparatuses in which the systems 100 are implemented include, but are not limited to, one or more server computers, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer, and other computing devices or systems.

In accordance with the described techniques, each of the systems 100 includes a processor core 102, and a processor-core extension depicted as having a cache extension 104 and/or a floating-point unit, FPU 106. The processor core 102 includes a first order (e.g., Nth order, level one or simply “L1”) data/instruction cache 108, a corresponding first order cache load store unit labeled as LSU 110, and a next order (e.g., N+1 order, level two or simply “L2”) cache LSU labeled as LSU 112. The cache extension 104 in each of the systems 100 represents a next order (e.g., N+1 order, level two or simply “L2”) cache and includes a next order (e.g., level two) cache controller 114. The cache extension 104 is a higher order cache than the data/instruction cache 108, and for ease of description, is referred to throughout this disclosure as being a L2 cache, which extends the capability of a L1 cache implemented in part with the data/instruction cache 108. In one or more implementations, the cache extension 104 is a third or higher order cache (e.g., level three or “L3), and the data/instruction cache 108 is a second or lower order cache (e.g., L2).

The processor core 102, the cache extension 104, and the FPU 106 are communicably couplable via interconnects or links (not shown for simplicity of the drawings). Further, one or more of the various components of the processor core 102 (e.g., the data/instruction cache 108, the LSU 110, the LSU 112) are communicably coupled via interconnects or links (not shown for simplicity of the drawings) to one or more of the various components of the cache extension 104 (e.g., the cache controller 114) and/or one or more components of the FPU 106.

In at least one variation, the processor core 102, the cache extension 104, and the FPU 106 are incorporated within the semiconductor device 116 as part of a common circuit board, e.g., a system-on-chip (SoC), a system-on-package (SoP). In at least one aspect, the semiconductor device 116 supports the components of each of the systems 100 using three-dimensional (3D) stacking. The semiconductor device 116 includes integrated-circuit (IC) substrates on a plurality of dies that support a plurality of different chip layers containing elements of the processor core 102, the cache extension 104, and the FPU 106.

The processor core 102 is an electronic circuit that perform various operations on and/or using data in the cache extension 104 and the data/instruction cache 108. Examples of the processor core 102 include, but are not limited to, a processing core of a central processing unit (CPU), a graphics processing unit (GPU), a field programmable gate array (FPGA), an accelerator, an accelerated processing unit (APU), and a digital signal processor (DSP), to name a few. The processor core 102 is an individual processing unit that reads and executes instructions (e.g., of a program), examples of which include to add, to move data, and to branch. In one or more variations, the processor core 102 includes multiple cores (i.e., the processor core 102 is for a multi-core processor). In other variations, the processor core 102 include only one core (i.e., the processor core 102 includes a single processor core).

In at least one example, the cache extension 104 and the data/instruction cache 108 are a processor-core extension of components that store data (e.g., at least temporarily) so that a future request for the data is served faster from the cache extension 104 or the data/instruction cache 108 than from a data store maintained outside the systems 100 (e.g., in another memory that is not shown). For example, as an instruction cache, the cache extension 104 and the data/instruction cache 108 serve instructions or partial instructions for executing functions. As a data cache, as a data cache, the cache extension 104 and the data/instruction cache 108 serve data or partial data for executing instructions. Examples of a data store include main memory (e.g., random access memory), a higher-level cache than either the cache extension 104 and the data/instruction cache 108 (e.g., a L3 cache when the data/instruction cache 108 is a L1 cache and the cache extension 104 is a L2 cache), secondary storage (e.g., a mass storage device), and removable media (e.g., flash drives, memory cards, compact discs, and digital video disc). In one or more implementations, the data/instruction cache 108 and the cache extension 104 are each at least one of smaller than the data store, faster at serving data to a requestor than the data store, or more efficient at serving data to the requestor than the data store. Additionally, or alternatively, as depicted in FIG. 1, the data/instruction cache 108 and the cache extension 104 are each located closer to a requestor (e.g., the processor core 102) than a data store. It is to be appreciated that in various implementations the data/instruction cache 108 and the cache extension 104 have additional or different characteristics which make serving at least some data to a requestor from the data/instruction cache 108 or the cache extension 104 advantageous over serving such data from a data store.

In one or more implementations, the data/instruction cache 108 and the cache extension 104 are examples of a memory cache, such as a particular level of cache (e.g., L1 cache) that is included in a hierarchy of multiple cache levels (e.g., L0, L1, L2, L3, and L4). The data/instruction cache 108 and the cache extension 104 are hardware components built into and used by a requestor, e.g., built into the systems 100 and used by the processor core 102. In one or more examples, the data/instruction cache 108 and/or the cache extension 104 are implemented at least partially in software or implementable in different ways without departing from the spirit or scope of the described techniques.

The data/instruction cache 108 is at least partially controlled by the LSU 110. The LSU 110 coordinates transfers of data between registers or other logic units of the processor core 102 and the data/instruction cache 108. The LSU 110 communicates with the data/instruction cache 108 using signals to cause data to be stored within or loaded from the data/instruction cache 108. In at least one implementation, the LSU 110 maintains one or more queues, for example, referred to as a Load Queue (LDQ) and a Store Queue (STQ). When the processor core 102 executes an instruction requiring data to be loaded from memory or storage, the LSU 110 calculates a load address for that instruction and enters the calculated load address into the LDQ. If there is a cache hit, data at the load address is communicated from the data/instruction cache 108 to the processor core 102. When the processor core 102 executes an instruction requiring data to be stored at the memory or storage, the LSU 110 generates a store address and determines a store data value, both of which are entered in the STQ. If there is a cache hit, the store data and the store address are communicated from the processor core 102 to the data/instruction cache 108.

The LSU 112 shares similar functionality of the LSU 110 for controlling operations performed using the cache extension 104. The LSU 112 tends to be slower than the LSU 110. The LSU 110 is suited for performing low-latency and high-bandwidth operations that improve performance of the processor core 102. In contrast, the LSU 112 handles larger amounts of data and achieves higher throughput than the LSU 110. The LSU 112 communicates with the cache controller 114 by sending signals to the cache controller 114 to cause data to be stored within or loaded from the cache extension 104.

The cache extension 104 is controlled by the cache controller 114 based on signals generated by the LSU 112. When the processor core 102 executes an instruction requiring data to be loaded from a memory or storage, the LSU 110 calculates a load address for that instruction and enters the calculated load address into the LDQ. If there is a cache miss at the data/instruction cache 108, the LSU 110 triggers the LSU 112 to check the cache extension 104. The LSU 112 enters the load address into its own LDQ, and if there is a cache hit at the cache extension 104, the LSU 112 causes the cache controller 114 to retrieve data from the cache extension 104, which is then communicated from the cache extension 104 to the processor core 102.

When the processor core 102 executes an instruction requiring data to be stored at the memory or storage, the LSU 110 generates a store address and determines a store data value, both of which are loaded to the SDQ of the LSU 110. If there is a cache miss at the data/instruction cache 108, the LSU 110 triggers the LSU 112 to check the cache extension 104. The LSU 112 enters the store address and the store value into its own SDQ, and if there is a cache hit at the cache extension 104, the LSU 112 causes the cache controller 114 to maintain the store value and the store address at the cache extension 104. The store value and the store address are communicated from the LSU 112 to the cache controller 114 for writing to the cache extension 104.

The cache controller 114 manages the retrieval, storage, and delivery of data at the cache extension 104. The cache controller 114 determines where to store new data, when to fetch additional data from adjacent addresses to be ready in case the processor core 102 uses the data soon after, and what old data to discard from the cache extension 104 if the cache extension 104 is full. In one or more implementations, to improve performance of the cache extension 104, the cache controller 114 maintains a table of addresses associated with data already stored in the cache extension 104. The cache controller 114 checks the table to determine if the LSU 112 is referencing data that is already present in memory of the cache extension 104.

In at least one implementation, as a floating-point unit, the FPU 106 performs operations on floating-point numbers or fractions. In one or more aspects, the FPU 106 is operable to implement various arithmetic operations such as addition, subtraction, multiplication, division, square roots, exponential functions, and trigonometric calculations. In one or more examples, the FPU 106 includes dedicated floating-point registers for receiving inputs and providing outputs from and to one or more components of the processor core 102.

The system 100-1 is an example where no stacked die extensions are used. The system 100-1 includes the cache extension 104 and the FPU 106 on the same die of the semiconductor device 116 as the processor core 102. As depicted in FIG. 1, the cache extension 104 (e.g., L2 cache) and the cache controller 114 are positioned on a far-right side of the same die of the semiconductor device 116, which is far away from the processor core 102, the data/instruction cache 108, the LSU 110, and the LSU 112. In addition, the FPU 106 is positioned far away from the processor core 102 on a far-left side of the same die of the semiconductor device 116.

When the cache extension 104 and/or the FPU 106 are arranged on the same die of the semiconductor device 116, but far away from, the processor core 102 and the other supporting components, performance of the system 100-1 suffers. Communication latency between the LSU 112 and the cache controller 114 is high, as is complexity of power and signal routing between them. In addition, overall thermal management of the elements on the semiconductor device 116 is more difficult because the processor core 102 runs hotter than the cache extension 104 and/or the FPU 106. Rather than a consistent thermal footprint across the semiconductor device 116, the system 100-1 has die regions that produce more less heat than the processor core 102. A complicated heatsink design is used to cool distinct regions of the semiconductor device 116 differently.

In accordance with techniques of this disclosure, which improve thermal management, communication latency, and routing complexity within the semiconductor device 116, the system 100-2, the system 100-3, and the system 100-4 each include a stacked die extension including at least one die that is vertically arranged adjacent to (e.g., over, under) a main die of the semiconductor device 116 containing the processor core 102.

Turning first to the system 100-2, the cache extension 104 and the cache controller 114 are an example of a processor-core extension that is positioned within at least one vertical die (e.g., an adjacent die) of the semiconductor device 116, which is either above or below a main die of the semiconductor device 116 on which a portion of the processor core 102 is arranged. The cache extension 104 within the system 100-2 is located above parts of the processor core 102 that often utilize the cache extension 104. As depicted in FIG. 1, the cache extension 104 is arranged above the portion of the processor core 102 that includes the data/instruction cache 108, the LSU 110, and/or the LSU 112. In one or more implementations, at least part of the data/instruction cache 108 is located on the main die of the semiconductor device 116, which is under at least one vertical die (e.g., an adjacent die) supporting the cache extension 104. In at least one implementation, the at least one vertical die containing the cache extension 104 is arranged above the LSU 110 and/or above the LSU 112.

Next, with reference to the system 100-3, the FPU 106 is a processor-core extension that is positioned within at least one vertical die (e.g., an adjacent die) of the semiconductor device 116, which is either above or below a main die of the semiconductor device 116 on which a portion of the processor core 102 is arranged. The FPU 106 within the system 100-3 is located above parts of the processor core 102 that often utilize the FPU 106. Because the FPU 106 is on at least one different die than the processor core 102, the FPU 106 is sometimes referred to as a floating-point extension (e.g., the FPU 106 is extended to a vertical die of the semiconductor device 116).

Finally, the system 100-4 is an implementation where both the FPU 106 (i.e., the floating-point extension) and the cache extension 104 represent a processor-core extension positioned within at least one vertical die of the semiconductor device 116, which is either above or below a main die (e.g., a bottom die) of the semiconductor device 116 on which a portion of the processor core 102 is arranged. The cache extension 104 is placed over components of the processor core 102 that often communicate with the cache controller 114, and the FPU 106 is likewise placed over components of the processor core 102 that initiate or benefit from calculations performed by the FPU 106.

In one or more implementations, another type of processor-core extension (e.g., a programmable accelerator extension, a matrix extension for matrix math, a branch prediction unit, an artificial intelligence accelerator, an audio accelerator, a video accelerator, a cryptography extension for encryption or decryption of data exchanged with the processor core 102) is implemented alone or in combination with the cache extension 104 and/or the FPU 106. This processor-core extension is implemented in the system 100-2, the system 100-3, and the system 100-4 with the processor-core extension being arranged on at least one vertical die of the semiconductor device 116. Placement of the processor-core extension causes the distance to other components of the processor core 102 to be less than if implemented in the system 100-1.

In each of the system 100-2, the system 100-3, and the system 100-4, when the cache extension 104 and/or the FPU 106 are arranged on at least one vertical die of the semiconductor device 116, the distance between them and the components of the processor core 102 on the main die of the semiconductor device 116 is less than similar components found in the system 100-1. By stacking the FPU 106 and/or the cache extension 104, as is done in the system 100-2, the system 100-3, and the system 100-4, performance is improved. Signal and power are routed vertically (e.g., in the z-direction) between the FPU 106 and/or the cache extension 104 and the processor core 102, which simplifies the design and reduces communication latency, among other advantages. With the FPU 106 and/or the cache extension 104 arranged to be in closer proximity with the supporting units of the processor core 102, a consistent thermal footprint is achieved across the semiconductor device 116, which makes overall thermal management of the elements on the semiconductor device 116 easier. In one or more implementations, a less complex heatsink design is used to cool distinct regions of the semiconductor device 116 similarly. A heatsink for the system 100-2, the system 100-3, and the system 100-4 has a relatively uniform thickness to apply a same cooling function to each part of the semiconductor device 116, whereas a heatsink for the system 100-1 has a greater thickness over the processor core 102 than over the other parts of the system 100-1.

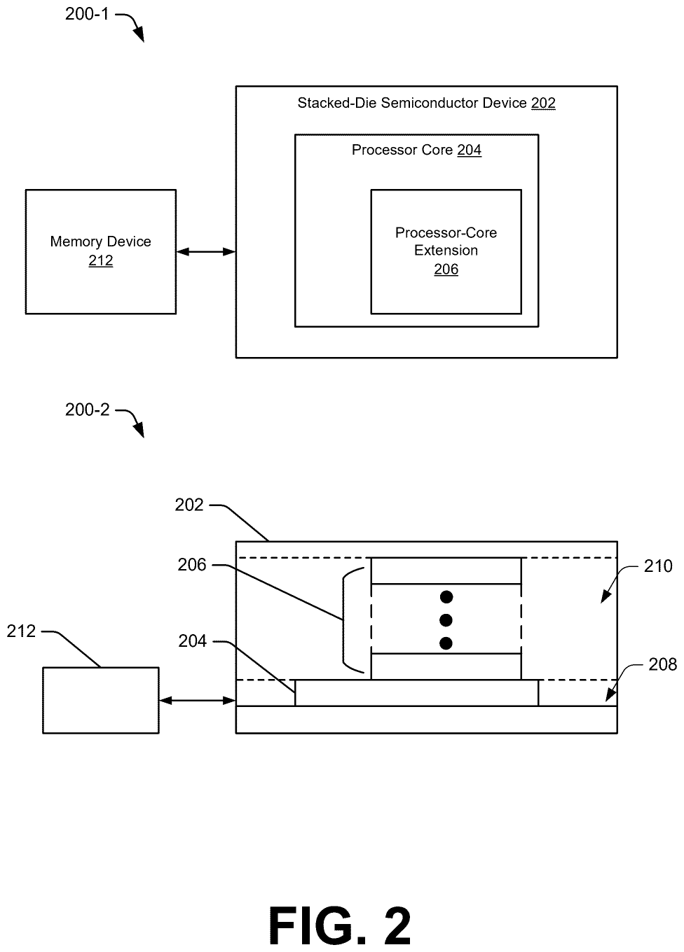

FIG. 2 depicts a non-limiting example top-view 200-1 and side-view 200-2 of a system with a stacked die extension over a processor core. As depicted in FIG. 1, a stacked-die semiconductor device, referred to as a semiconductor device 202, is depicted as an example of the semiconductor device 116 from FIG. 1. The semiconductor device 202 includes a processor core 204 arranged on a main die 208 (e.g., a bottom die) of the semiconductor device 202. The processor core 204 is an example of the processor core 102 from FIG. 1. The semiconductor device 202 also includes a processor-core extension 206 positioned within at least one vertical die 210 of the semiconductor device 202. Non-limiting examples of the processor-core extension 206 include a floating-point unit, a cache extension, a programmable accelerator extension, a matrix extension for matrix math, a branch prediction unit, an artificial intelligence accelerator, an audio accelerator, a video accelerator, and a cryptography extension for encryption or decryption of data exchanged with the processor core 204. For example, the at least one vertical die 210 includes a quantity of N dies, where N represents any positive integer. With further reference to the elements depicted in FIG. 1, the processor-core extension 206 is an example of the cache extension 104 (including the cache controller 114) taken alone (e.g., as in the system 100-2), the FPU 106 taken alone (e.g., as in the system 100-3), or a combination of the cache extension 104 and the FPU 106 (e.g., as in the system 100-4). Although primarily described with respect to cache and floating-point functions, the at least one vertical die 210 supports other variations of the processor-core extension 206, in other implementations. For example, rather than or in addition to the cache extension 104 or the FPU 106, the processor-core extension 206 integrated within the at least one vertical die 210 includes one or more of a programmable accelerator extension, a matrix extension for matrix math, a branch prediction unit, an artificial intelligence accelerator, an audio accelerator, a video accelerator, a cryptography extension for encryption or decryption of data exchanged with the processor core 204, and other type of hardware element or hardware block used to support functionality of the processor core 204.

The at least one vertical die 210 is depicted as having at least two dies arranged above a portion of the processor core 204, however, in one or more examples the at least one vertical die 210 is below the main die 208. For simplicity of the drawings, the main die 208 is depicted directly next to the at least one vertical die 210. In one or more implementations, additional dies of the semiconductor device 202 are arranged between the main die 208 and the at least one vertical die 210. In one or more implementations, the main die 208 is arranged between the at least one vertical die 210 (e.g., above a first vertical die and below a second vertical die). In one or more aspects, an interconnect layer, an epitaxial layer, an oxide layer, a polysilicon layer, and/or a metal layer of the semiconductor device 202 is located between the main die 208 with the processor core 204 and the at least one vertical die 210 with the processor-core extension 206. The vertical stacking of the processor-core extension 206 relative the processor core 204 reduces communication latency, routing complexity, and achieves a more consistent thermal footprint than if the processor-core extension 206 and the processor core 204 were implemented together on the main die 208.

Also depicted in FIG. 2 is a memory device 212 that is operatively coupled to the semiconductor device 202. The memory device 212 is configured to store and retrieve data exchanged with the processor core 204 and/or the processor-core extension 206. For example, the memory device 212 implements a data store accessed from the semiconductor device 202. Examples of the data store implemented by the memory device 212 includes a main memory (e.g., random access memory), a higher-level cache than either the first order cache, the second order cache, and/or the third order cache, a secondary storage (e.g., a mass storage device), and removable media (e.g., flash drives, memory cards, compact discs, and digital video disc).

As one example implementation, the semiconductor device 202 provisions a multi-level cache that supports operations of the processor core 204. For example, the main die 208 includes a first order cache (e.g., L1 cache) arranged near or among elements of the processor core 204. The at least one vertical die 210 includes at least two dies, including at least one second die and at least one third die, which are arranged above or below this first order cache. A second order cache (e.g., L2 cache) is implemented on the at least one second die, which is adjacent to and stacked vertically from the main die 208. A third order cache (e.g., L3 cache) is implemented on the at least one third die, which is stacked adjacent to an opposite side of the second die that is adjacent to the main die 208. The memory device 212 is operatively coupled to the semiconductor device 202 to exchange data to be stored at or retrieved from the memory device 212 on behalf of the processor-core extension 206 (e.g., the first order cache, the second order cache, the third order cache) and/or the processor core 204. In this way, the processor-core extension 206 provides at least two additional cache layers beyond the first order cache implemented on the main die 208 within the processor core 204. With the additional cache layers arranged vertically above or below the first order cache, elements of the additional cache layers are positioned closer to elements of the first order cache than if they are arranged on the main die 208 outside the processor core 204, which improves performance of the multi-level cache. In at least one variation, the multi-level cache includes more than three cache layers (e.g., the at least one vertical die 210 includes at least one fourth die to expand capacity of the third order cache or provision a fourth order cache). In one or more examples, these additional cache layers are implemented on a single vertical die. In one or more implementations, an additional cache layer is implemented on multiple vertical dies.

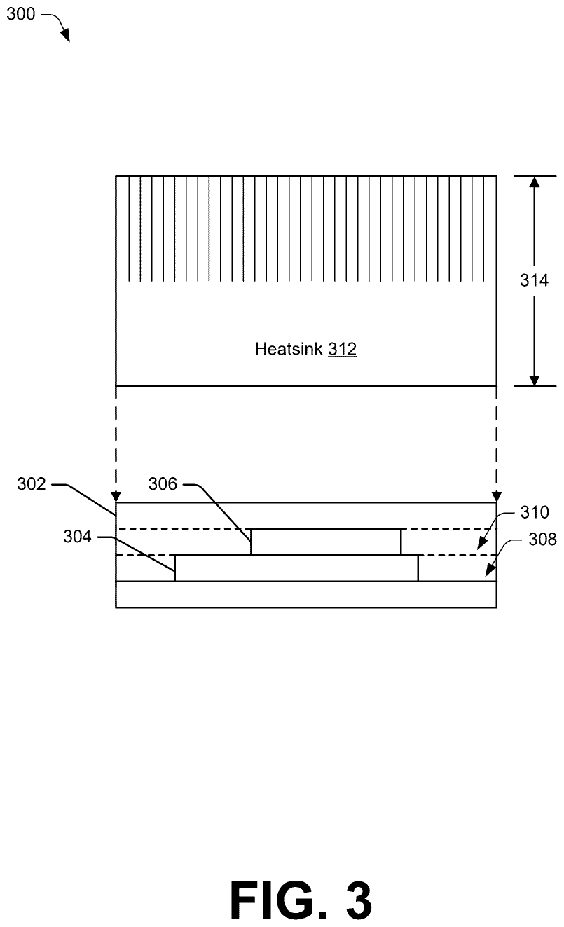

FIG. 3 depicts a non-limiting example 300 of a stacked die extension over a processor core being cooled by a heatsink. A stacked-die semiconductor device referred to as a semiconductor device 302 is depicted in FIG. 3. The semiconductor device 302 is an example of the semiconductor device 116 and the semiconductor device 202. The semiconductor device 302 includes a processor core 304, which is an example of the processor cores 102 and 204, arranged on a main die 308 of the semiconductor device 302. The semiconductor device 302 also includes a processor-core extension depicted as a floating-point/cache extension 306 positioned within at least one vertical die 310 of the semiconductor device 302. The floating-point/cache extension 306 is an example of the processor-core extension 206, including one or more variations of the cache extension 104 and/or the FPU 106 depicted in FIG. 1.

As depicted in FIG. 3, the components of the semiconductor device 302 are cooled by a heatsink 312. The heatsink 312 is configured to dissipate thermal energy generated from the processor core 304 and the floating-point/cache extension 306. With the at least one vertical die 310 including the floating-point/cache extension 306 arranged between the main die 308 and the processor core 304, the heatsink 312 is configured to cool the elements evenly across the semiconductor device 302. As depicted in FIG. 3, the heatsink 312 has (approximately) a uniform thickness 314 relative distinct areas of the semiconductor device 302 where the floating-point/cache extension 306 and the processor core 304 are arranged. This simpler design of the heatsink 312 is sufficient to cool the various regions of the semiconductor device 302 because stacking the floating-point/cache extension 306 over or under the processor core 304 achieves a consistent heat signature across the semiconductor device 302. In one or more implementations, a more complicated heatsink design is used (e.g., the uniform thickness 314 is not achieved across the semiconductor device 302) for addressing heat signature variability on the semiconductor device 302, which is caused by other factors that are unrelated to the stacking of the floating-point/cache extension 306 over or under the processor core 304. In aspects, the heatsink 312 achieves the uniform thickness 314 over the floating-point/cache extension 306 and part of the processor core 304, and a variable thickness in places where the processor core 304 and other elements on the main die do not overlap with the floating-point/cache extension 306.

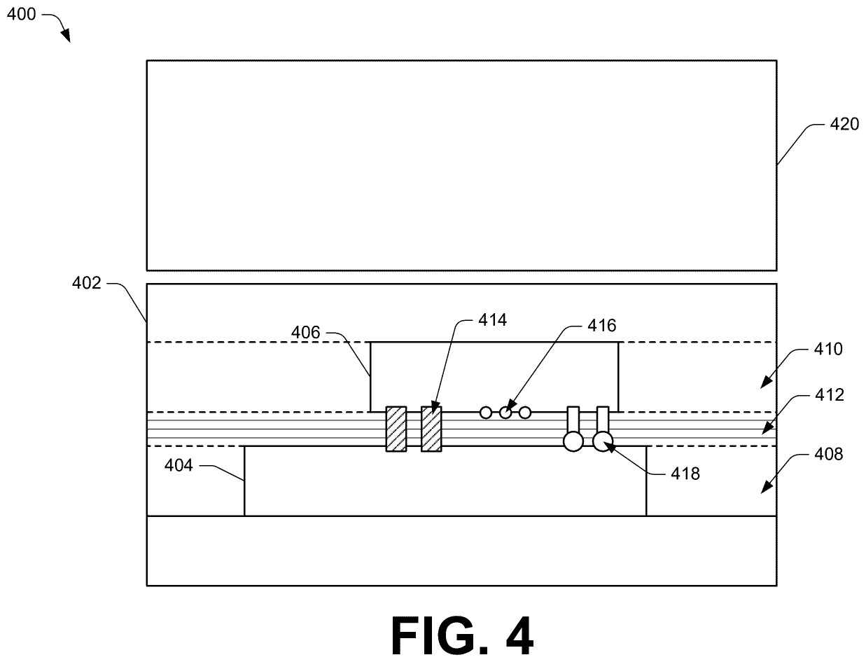

FIG. 4 depicts a non-limiting example 400 of a stacked die extension over a processor core including one or more die-to-die interconnects. A stacked-die semiconductor device, referred to as a semiconductor device 402, is depicted in FIG. 4 as an example of the semiconductor device 116, the semiconductor device 202, and the semiconductor device 302. The semiconductor device 402 includes a processor core 404, which is an example of the processor core 102, the processor core 204, and the processor core 304. The processor core 404 is arranged on a main die 408 of the semiconductor device 402. In one or more implementations, the main die 408 is a bottom die or a top die of the semiconductor device 402. The semiconductor device 402 also includes a processor-core extension depicted as a floating-point/cache extension 406 positioned within at least one vertical die 410 of the semiconductor device 402. The floating-point/cache extension 406 is an example of the processor-core extension 206 and floating-point/cache extension 306, including one or more variations of the cache extension 104 and/or the FPU 106 depicted in FIG. 1 with reference to the system 100-2, the system 100-3, and the system 100-4.

The floating-point/cache extension 406 is operatively coupled to the processor core 404. As depicted in FIG. 4, the semiconductor device 402 includes an interconnect layer 412, which is positioned between the main die 408 and the at least one vertical die 410. The interconnect layer 412 includes at least one a die-to-die interconnect arranged between the main die 408 and the at least one vertical die 410. The die-to-die interconnect(s) are configured to transfer power and signals between the processor core 404 and the floating-point/cache extension 406. The die-to-die interconnect(s) of the interconnect layer 412 extend perpendicularly from the main die 408 to the at least one vertical die 410. Power and signals move vertically between the processor core 404 and the floating-point/cache extension 406 in a z-direction that is approximately perpendicular to an x-y plane of the main die 408. The distance between the processor core 404 and the floating-point/cache extension 406 caused by stacking in this way is less than if the processor core 404 and the floating-point/cache extension 406 are both implemented on the main die 408. The shorter distance between the processor core 404 and the floating-point/cache extension 406 improves communication latency through the die-to-die interconnect(s) in addition to simplifying complexity of their routing.

The interconnect layer 412 supports any type of vertical die-to-die interconnect. Some non-limiting examples of die-to-die interconnects are depicted in FIG. 4. In one or more implementations, multiple types of die-to-die interconnects are used in combination within the interconnect layer 412.

In at least one implementation, the interconnect layer 412 includes one or more through-silicon vias, labeled as TSVs 414, configured to transfer the power and signals between the processor core 404 and the floating-point/cache extension 406. The TSVs 414 represent vertical wires that electrically couple the stacked dies (e.g., the main die 408 and the at least one vertical die 410). The TSVs 414 are formed by etching trenches into silicon of interconnect layer 412, which are filled with metal wires (e.g., copper) and an insulating material.

In one or more examples, the interconnect layer 412 includes one or more micro bumps, labeled as micro bumps 416, configured to transfer the power and signals between the processor core 404 and the floating-point/cache extension 406. The micro bumps 416 represent small solder bumps that electrically couple the stacked dies (e.g., the main die 408 and the at least one vertical die 410). In aspects, the micro bumps 416 are made from metal alloys such as copper, nickel, gold, and silver, which are soldered using solder materials such as indium, tin, and compounds like tin-silver-copper (SAC).

In one or more implementations, the interconnect layer 412 includes one or more hybrid bonds, labeled as hybrid bonds 418, configured to transfer the power and signals between the processor core 404 and the floating-point/cache extension 406. The hybrid bonds 418 are different than the TSVs 414 and the micro bumps 416. The hybrid bonds 418 are formed using a combination of dielectric bonds and embedded metal materials.

As depicted in FIG. 4, the components of the semiconductor device 402 are cooled by a heatsink 420. The heatsink 420 is an example of the heatsink 312 and is configured to dissipate thermal energy generated from the processor core 404 and the floating-point/cache extension 406. The interconnect layer 412 preserves the uniformity of the heat signature caused across the semiconductor device 402 due to the stacking of the floating-point/cache extension 406 over or under the processor core 404. The consistent thermal footprint across the semiconductor device 402 allows implementations of the heatsink 420 to have a uniform thickness to regulate heat dissipation.

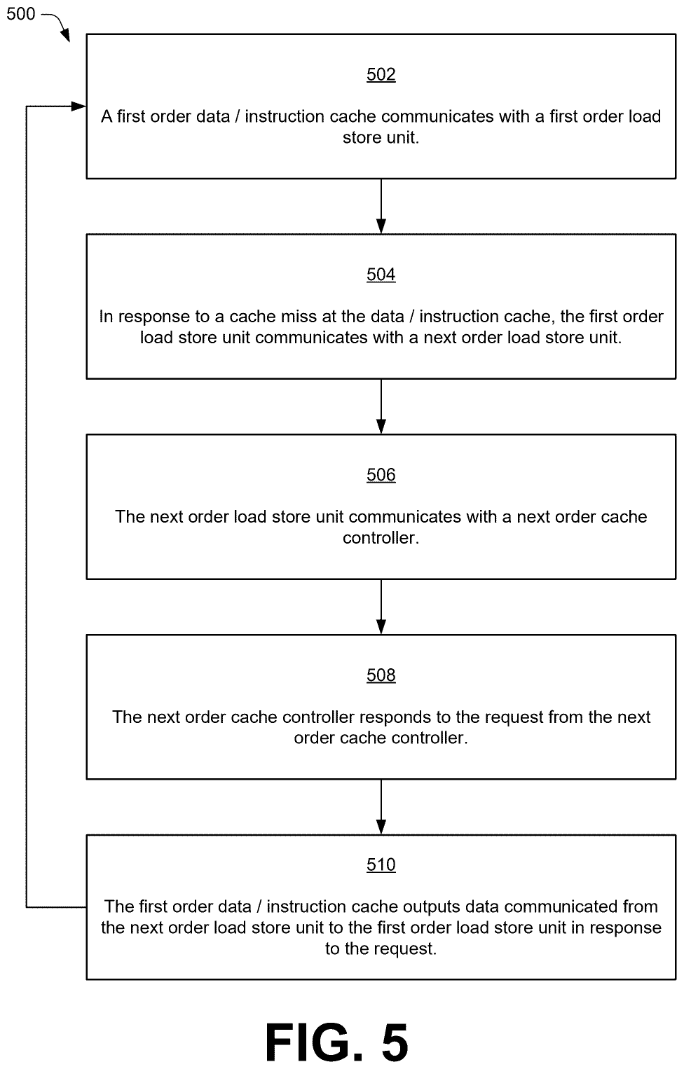

FIG. 5 depicts a procedure 500 performed in an example implementation of a stacked die extension over a processor core. For example, the procedure 500 occurs within the semiconductor device 116, the semiconductor device 202, the semiconductor device 302, or the semiconductor device 402.

A first order data/instruction cache communicates with a first order load store unit (block 502). In operation, when the data/instruction cache 108 is accessed, the LSU 110 performs a lookup to determine whether a cache request is a hit or miss.

In response to a cache miss at the data/instruction cache, the first order load store unit communicates with a next order load store unit (block 504). The LSU 110 sends a request to the LSU 112 to check the cache extension 104. At this point, communication between the data/instruction cache 108 and the LSU 110, as well as communication between the LSU 110 and the LSU 112 occurs within an interconnect located on a main die of the semiconductor device 116 containing the processor core 102.

The next order load store unit communicates with a next order cache controller positioned above the next order load store unit (block 506). The LSU 112 sends a control signal from the main die of the semiconductor device 116 to the cache controller 114 located with the cache extension 104 on at least one vertical die of the semiconductor device 116. The control signal is communicated from the LSU 112 to the cache controller 114 on a die-to-die interconnect that provides a vertical (e.g., z-direction relative the main die with the processor core 102) route or signal path.

The next order cache controller responds to the request from the next order cache controller (block 508). The cache controller 114 performs a lookup within the cache extension 104 to access data associated with the request. The cache controller 114 sends a response to the request back to the LSU 112 on the same route or signal path as the request, or a different vertical route or signal path formed between the cache extension 104 and the LSU 112 on the main die of the semiconductor device 116.

The first order data/instruction cache outputs data communicated from the next order load store unit to the first order load store unit in response to the request (block 510). The LSU 110 receives the response to the request from the LSU 112 and sends the data indicated in the response to the data/instruction cache 108.

By repositioning the cache extension 104 over the data/instruction cache 108, the LSU 110, and the LSU 112 (e.g., as-is with the system 100-2 and the system 100-3), the communication latency between the first order cache and the next order cache is reduced relative the system 100-1. Stacking the cache extension 104 in this way eliminates having to send signals from the LSU 112 across the main die of the semiconductor device 116 in a lateral direction (e.g., x-direction, y-direction). Instead, these signals are transmitted in the—direction on a die-to-die interconnect that has a much shorter route. With the cache extension 104 stacked on top of, or near, the data/instruction cache 108, multi-cycle lateral routes are eliminated. Instead, a short z-dimension route of a few (e.g., one, two) cycles is used to access the cache extension 104. In the context of FIG. 5, the cache extension 104 becomes more centrally located to the processor core 102 and elements contained within the processor core 102 where the cache extension 104 is utilized.

Another benefit of repositioning the cache extension 104 over the data/instruction cache 108, the LSU 110, and the LSU 112 is that enlarging the cache extension 104 is less complex because the area or footprint of the cache extension 104 is not constrained by the limited area available next to the processor core 102. Normally, increasing cache size adds significant area to a footprint of a semiconductor die, and manufacturing becomes difficult when the footprint is already constrained to a particular size or shape. With a larger cache, signals travel farther, and the addresses are larger. A larger cache increases latency by requiring more clock cycles to perform a lookup and transfer data back and forth.

In an implementation of a traditional design like the system 100-1, communication with the cache extension 104 takes around 14 cycles. Communication between the LSU 110, the LSU 112, and the cache controller 114 takes ten cycles, and the cache controller 114 takes four more cycles to access the cache extension 104. If the size of the cache extension 104 is doubled and not stacked over the processor core 102, the cache controller 114 takes four more cycles to access the cache extension 104, bringing the total latency to eighteen cycles.

In an implementation where the cache extension 104 is stacked similar to the system 100-2 and the system 100-4, increasing a size of the cache extension 104 does not increase communication latency as much as if the cache extension 104 is on the same die of the semiconductor device 116 as the processor core 102. Stacking allows the cache extension 104 to have a greater size and lower latency than even a smaller cache located next to the processor core 102. Stacking the cache extension 104 reduces the communication latency between the LSU 110, the LSU 112, and the cache controller 114 to be around zero cycles. The cache controller 114 still takes four more cycles to access the cache extension 104 (or eight cycles if the cache extension 104 is doubled in size). Even with a much larger size, communication with the cache extension 104 when stacked over the processor core 102 is much less than if the cache extension 104 is not stacked.

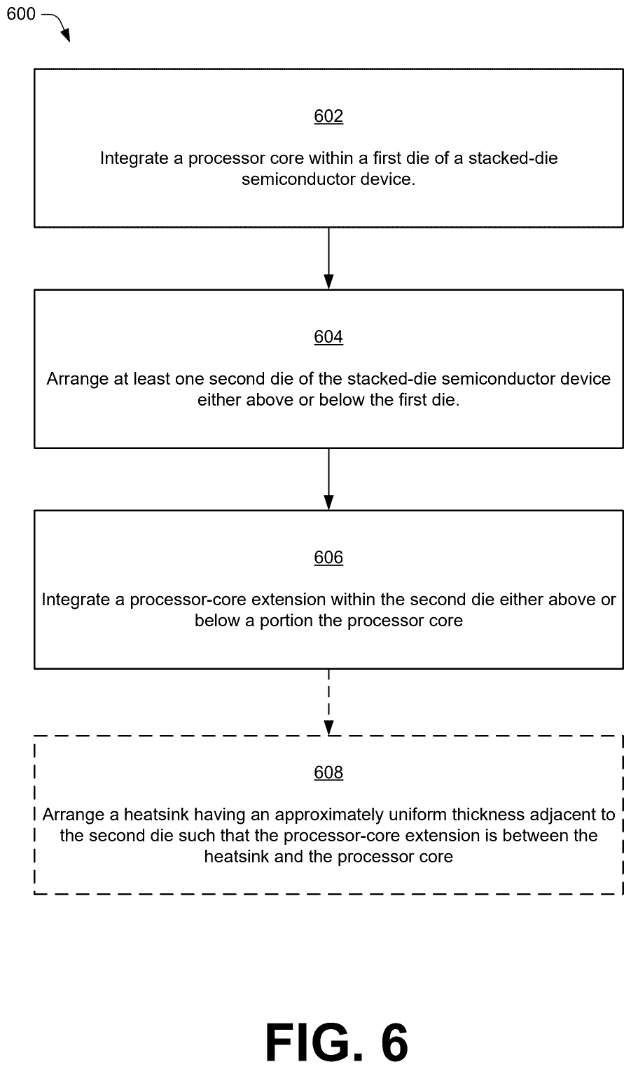

FIG. 6 depicts a procedure 600 for forming an example implementation of a stacked die extension over a processor core. The procedure 600 is implemented at least in part using semiconductor die manufacturing equipment, which executes a program or application to control machinery configured to construct any of the semiconductor device 116, the semiconductor device 202, the semiconductor device 302, and the semiconductor device 402 described herein, including to integrate their corresponding components.

A processor core is integrated within a first die of a stacked-die semiconductor device (block 602). In one or more implementations, manufacturing equipment performs semiconductor manufacturing techniques to form the processor core 102 within the main die (e.g., bottom die) of the semiconductor device 116.

At least one second die of the stacked-die semiconductor device is arranged either above or below the first die (block 604). By way of example, the manufacturing equipment performs semiconductor manufacturing techniques to add at least one vertical die to the semiconductor device 116 that is above or below the main die supporting the processor core 102.

A processor-core extension is integrated within the second die either above or below a portion the processor core (block 606). By way of example, the manufacturing equipment performs semiconductor manufacturing techniques to integrate a processor-core extension that supports the processor core 102 (e.g., the cache extension 104 and/or the FPU 106) within the at least one vertical die of the semiconductor device 116 that is above or below the processor core 102. Non-limiting examples of the processor-core extension that is integrated within the second die include a floating-point unit, a cache extension, a programmable accelerator extension, a matrix extension for matrix math, a branch prediction unit, an artificial intelligence accelerator, an audio accelerator, a video accelerator, and a cryptography extension for encryption or decryption of data exchanged with the processor core 102.

In one or more aspects, the processor-core extension integrated in the at least one vertical die includes the cache extension 104, which in one or more implementations includes a level two or level three cache. The portion of the processor core 102 (e.g., the data/instruction cache 108) over which the cache extension is arranged includes a level one cache, in one or more variations. Integrating the cache extension 104 includes arranging this level two or level three cache above or below a level one data/instruction cache or a level one load store unit.

In at least one implementation, the processor core 102 includes the data/instruction cache 108 as a first order cache, and the at least one second die of the semiconductor device 116 includes a plurality of dies. In this case, integrating the processor-core extension (e.g., the cache extension 104) within the second die includes implementing a second order cache and a third order cache within different dies from the plurality of dies that implement the processor-core extension. For example, as depicted in FIG. 2, the at least one vertical die 210 includes a quantity of N dies, where N represents any positive integer. An L2 cache is implemented within a first group of one or more dies included in the at least one vertical die 210 and a L3 cache is implemented within a different group of one or more dies included in the at least one vertical die 210.

Optionally, a heatsink having an approximately uniform thickness is arranged adjacent to the second die such that the processor-core extension is between the heatsink and the processor core (block 608). By way of example, the manufacturing equipment performs semiconductor manufacturing techniques to attach a heatsink (e.g., the heatsink 312, the heatsink 420) atop the processor-core extension (e.g., the cache extension 104 and/or the FPU 106), and above the processor core 102. The heatsink attached to the at least one vertical die in one or more implementations has a uniform thickness to provide thermal dissipation, which due to the stacking, produces a consistent heat signature across the semiconductor device 116.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a CPU, a DSP, a GPU, a parallel accelerated processor, a plurality of microprocessors, one or more microprocessors in association with a DSP core, a controller, a microcontroller, an Application Specific Integrated Circuit (ASIC), a FPGA circuit, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read-only memory (ROM), a random-access memory (RAM), a register, cache memory, semiconductor memory devices, magnetic media such as internal hard disks and removable disks, magneto-optical media, and optical media such as a CD-ROM disk, or a digital versatile disk (DVD).

What is claimed is:

1. A stacked-die semiconductor device comprising:
a first die having a processor core; and
at least one second die including a processor-core extension positioned either above or below a portion of the processor core.

2. The stacked-die semiconductor device of claim 1, wherein the processor-core extension comprises a cache extension operatively coupled to the processor core.

3. The stacked-die semiconductor device of claim 2, wherein the first die further comprises a cache operatively coupled to the cache extension.

4. The stacked-die semiconductor device of claim 3, wherein the cache extension is a higher order cache than the cache within the first die.

5. The stacked-die semiconductor device of claim 3, wherein the portion of the processor core comprises at least part of the cache within the first die.

6. The stacked-die semiconductor device of claim 3, wherein the portion of the processor core comprises at least one of a data cache of the cache within the first die, a load store unit of the cache within the first die, or a load store unit of the cache extension.

7. The stacked-die semiconductor device of claim 3, wherein the cache within the first die comprises a first order cache operatively coupled to the processor core, the cache extension comprises a second order cache operatively coupled to the processor core, and the stacked-die semiconductor device further comprises at least one third die with a third order cache operatively coupled to the processor core.

8. The stacked-die semiconductor device of claim 1, further comprising a die-to-die interconnect arranged between the first die and the at least one second die to transfer power and signals between the processor core and the processor-core extension.

9. The stacked-die semiconductor device of claim 8, wherein the die-to-die interconnect comprises at least one of micro bumps, hybrid bonds, or through-silicon vias.

10. The stacked-die semiconductor device of claim 1, wherein the processor-core extension comprises a floating-point unit operatively coupled to the processor core.

11. A system comprising:
a stacked-die semiconductor device that includes a first die that includes a processor core and at least one second die that includes a processor-core extension positioned either above or below a portion of the processor core; and
a memory device operatively coupled to the processor-core extension to exchange data with the processor core.

12. The system of claim 11, further comprising a heatsink configured to dissipate thermal energy from the stacked-die semiconductor device.

13. The system of claim 12, wherein the at least one second die is positioned between the first die and the heatsink.

14. The system of claim 13, wherein the heatsink comprises an approximately uniform thickness relative the processor-core extension and the processor core.

15. The system of claim 11, wherein the processor-core extension comprises a floating point unit operatively coupled to the processor core.

16. The system of claim 11, wherein the processor-core extension comprises a cache extension operatively coupled to the processor core.

17. The system of claim 11, wherein the processor-core extension comprises at least one of a programmable accelerator extension, a matrix extension for matrix math, a branch prediction unit, an artificial intelligence accelerator, an audio accelerator, a video accelerator, or a cryptography extension for encryption or decryption of the data exchanged with the processor core.

18. A method of forming a stacked-die semiconductor device, the method comprising:
integrating a processor core within a first die of the stacked-die semiconductor device;
arranging at least one second die of the stacked-die semiconductor device either above or below the first die; and
integrating a processor-core extension within the at least one second die either above or below a portion the processor core.

19. The method of claim 18, wherein the portion of the processor core comprises a level one cache and a level one load store unit, and integrating the processor-core extension comprises integrating a level two cache or a level three cache within the at least one second die either above or below the level one load store unit of the processor core.

20. The method of claim 18, further comprising:
arranging a heatsink having an approximately uniform thickness adjacent to the at least one second die such that the processor-core extension is between the heatsink and the processor core.
